(19) United States
(12) Patent Application Publication
(10) Pub. No.: US 2009/0003310 A1
(43) Pub. Date: Jan. 1, 2009

(54) Dynamic allocation of VOIP service resources

(76) Inventor: Bryan F. Kadel, Carol Stream, IL (US)

Correspondence Address: PATTI , HEWITT & AREZINA LLC, ONE NORTH LASALLE STREET, 44TH FLOOR, CHICAGO, IL, 60602, US

(21) Appl. No.: 11/823,139

(22) Filed: Jun. 27, 2007

(51) Int. Cl. H04L 12/28

(52) U.S. Cl. 370/351

(57) ABSTRACT

An exemplary method is implemented in a voice over internet protocol (VOIP) system for selecting communication nodes to carry requested call from a user. A primary VOIP service provider of the user determines that at least one communication node of another service provider is needed to carry a portion of the requested call. Conditions under which one or more other service providers with respective nodes suited for carrying the portion of the requested call would carry the portion of the call are determined on a per call basis, where the conditions include cost for the carrying of the portion of the call. One node of the one or more service providers is selected to carry the portion of the call based on predetermined rules that operated on the conditions. A path to carry the call is completed that includes the selected one node.

### BACKGROUND

This invention relates to voice over internet protocol (VOIP) services and more specifically to dynamically determining routing of a user requested VOIP communication link using nodes of different VOIP service providers based on factors such as cost and availability.

A variety of different service providers offer VOIP services. A call request from a VOIP user may be handled entirely within a single service provider's network depending on the called party's location and the extent of coverage of the service provider. However, a VOIP call request received by the service provider may require the use of communication resources of one or more different service providers in order to provide a communication path to the called party. Assuming that resources are available from the different service providers needed to support a path to the called party, a determination must be made of which of the different service provider resources should be utilized to complete the requested call to the called party.

Typically, VOIP service providers will have entered into a service agreement with each other by which services are made available to other service providers. Such a service agreement may specify the cost basis on which services are made available to the other service providers and define a quantity of communication traffic to be handled at a given price. Such arrangements typically cover services to be provided over a substantial period of time, i.e. communication call services provided over the course of weeks or months. The routing of an individual VOIP call request is typically routed based on such long term bulk usage agreements. However, with increasing competition to provide users with better VOIP services at lower prices, an aspect of the present invention has identified a need for improved flexibility in selecting VOIP communication resources and corresponding service providers on a per call request basis.

### SUMMARY

It is an object of the present invention to satisfy this need.

An exemplary method of the present invention is implemented in a voice over internet protocol (VOIP) system for selecting communication nodes to carry a requested call from a user. A primary VIOP service provider of the user determines that at least one communication node of another service provider is needed to carry a portion of the requested call. Conditions under which one or more other service providers with respective nodes suited for carrying the portion of the requested call would carry the portion of the call are determined on a per call basis, where the conditions include cost for the carrying of the portion of the call. One node of the one or more service providers is selected to carry the portion of the call based on predetermined rules that operated on the conditions. A path to carry the call is completed that includes the selected one node.

Nodes that implement the above method provide another exemplary embodiment of the present invention.

### DESCRIPTION OF THE DRAWINGS

Features of exemplary implementations of the invention will become apparent from the description, the claims, and the accompanying drawings in which:

FIG. 1 is a block diagram of a network suited for incorporation of an embodiment of the present invention.

FIG. 2 is a diagram of illustrative nodes as shown in FIG. 1.

FIG. 3 is a flow diagram of illustrative steps for selecting service providers with nodes to carry at least a portion of a VOIP call on a per call basis in accordance with an embodiment of a method of the present invention.

### DETAILED DESCRIPTION

One aspect of the present invention resides in the recognition that improved flexibility in selecting available VOIP communication resources and corresponding service providers on a dynamic, i.e. per call request, basis will provide users with cost effective choices and provide a competitive advantage for service providers that offer such capabilities to users. This capability is further enhanced where the ability to dynamically select the service provider's resources can be based, at least in part, on a cost quoted by the service providers on a per call basis associated with use of their respective resources prior to the selection.

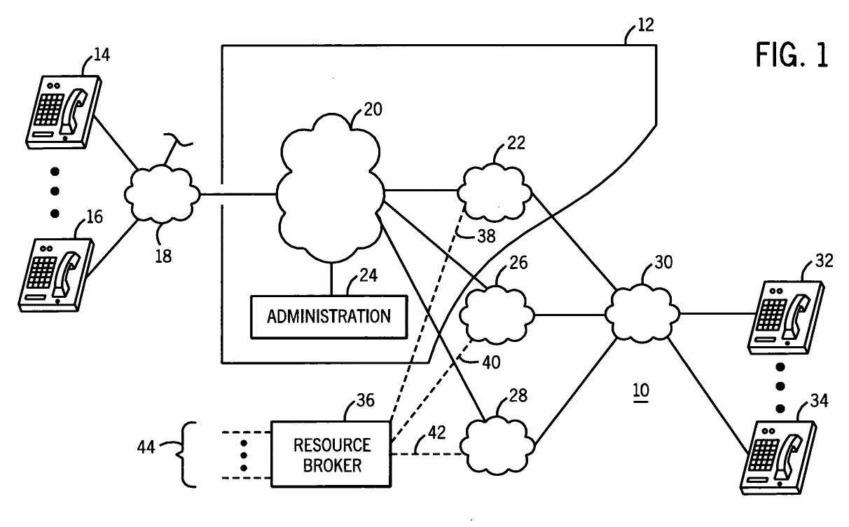

FIG. 1 shows a networking system 10 suited for incorporation of an embodiment of the present invention. A primary VOIP service provider includes resources contained within the boundary 12. As used herein, reference numeral 12 may either refer to the resources of the associated service provider or the service provider itself as will be apparent from the context. A plurality of VOIP users are associated with exemplary respective VOIP communication devices 14-16, e.g. VOIP telephone sets. The VOIP communication devices are intended to include all types of wireline and wireless apparatus capable of supporting VOIP calls and/or communication sessions such as computers, personal digital assistants, personal communication devices, etc. These communication devices are supported by an origination node 18 which could comprise a VOIP supporting node or a conventional telecommunications switch. In the illustrative example, node 18 may be supported by plurality of networks and/or networking elements in addition to the network resources provided by the service provider 12.

Service provider 12 supports communications with origination node 18 and includes a transport network 20, a peripheral node 22, and administration module 24. As will be explained in more detail below, the administration module 24 provides command and control functions for the network elements of service provider 12 as well as providing decisions concerning call path routing in accordance with present invention. Peripheral nodes 26 and 28 are associated with respective different service providers and include communication channels coupled to transport network 20. Each of the peripheral nodes 22, 26 and 28 are coupled to an exemplary terminating node 30 which may comprise a VOIP supporting node or a conventional telecommunications switch. Node 30 is coupled to and supports a plurality of VOIP communication devices 32-34 associated with respective users. Nodes 18 and 30 are referred to as the originating and terminating nodes, respectively, merely because the illustrative example explained below describes a call originated by the user associated with communication device 14 having a destination of the user associated with communication device 32. Those skilled in the art will understand that the nodes 18 and 30 will handle both origination and termination of calls with regard to the supported users.

A resource broker module 36 is coupled, as shown by the respective dashed lines 38, 40 and 42, to the nodes 22, 26 and 28, respectively. The resource broker module 36 is capable of bidirectional communications with service provider 12 by node 22, and with the other two respective service providers associated with nodes 26 and 28, respectively. Part of the functionality of the resource broker module 36 is to maintain and periodically update availability and cost information associated with providing telecommunication services by each of the respective service providers. Preferably this information is made available on a dynamic per call basis so that a primary service provider in charge of routing a VOIP call request can access this information prior to call path completion to a destination user. This gives the primary service provider information as to availability and cost associated with the selection of potential call paths, assuming that two or more service providers have nodes with available capacities to handle a pending call request. In the illustrative example, nodes 22, 26 and 28 may maintain the availability and cost information for the respective service providers or may serve as a transfer point to another node within each respective service provider, e.g. an administration module, that maintains the availability and cost information.

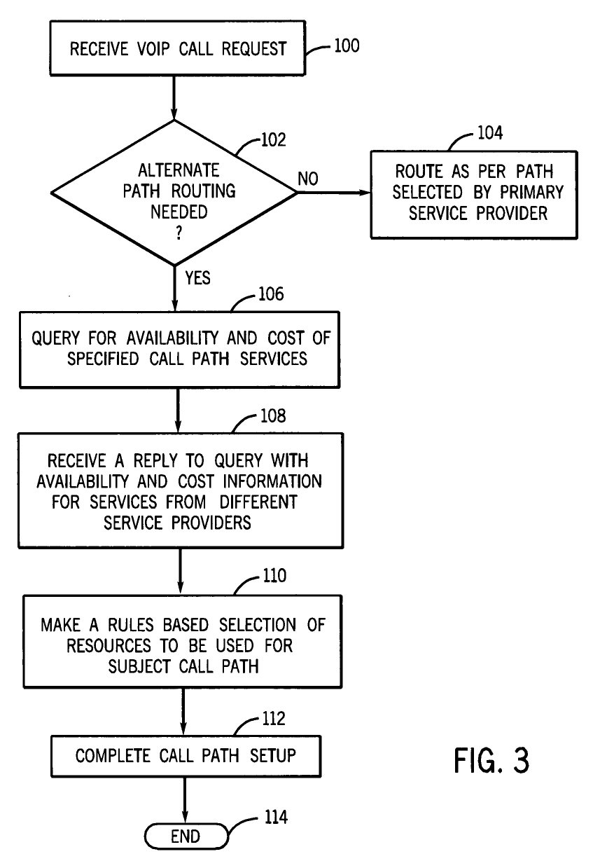

Assume that the user associated with VOIP device 14 originates a call request having the user associated with VOIP communication device 32 as the destination. Further assume that the service provider 12 is the primary service provider and that node 22, which is part of service provider 12, is already at full capacity and is not able to handle this additional call request. Because network 20 is also coupled to nodes 26 and 28 of different respective service providers, either of these nodes presents a potential call path to termination of 30 and ultimately to communication device 32. Before selecting either to become part of the requested call path, the administration module 24 of service provider 12 may query the resource broker module 36 as to availability and cost associated with using nodes 26 or 28 as part of the requested call path. Upon receipt of this information from the resource broker module 36, the administration module 24 of the primary service provider makes a decision of which of nodes 26 and 28 to utilize. Following this decision, the setup of a call path pursuant to the subject call path request through the selected node 26 or 28 is completed. A more detailed explanation of such an exemplary method is provided below with regard to FIG. 3.

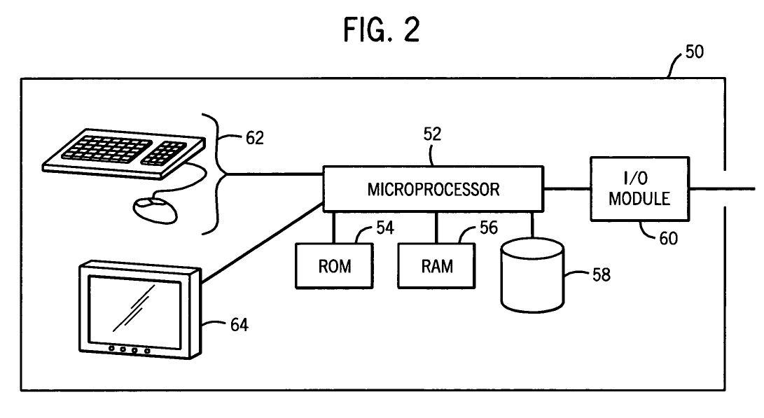

FIG. 2 is a block diagram of a node 50 such as used in the network is shown in FIG. 1. The architecture shown for node 50 could be utilized for the communication handling nodes, the administration module 24 and resource broker module 36. A microprocessor 52 is supported by read-only memory (ROM) 54, random access memory (RAM) 56, and nonvolatile data storage device 58 which may be a hard drive. An input/output module 60 is coupled to the microprocessor 52 and supports inbound and outbound communications with external devices. Input devices 62 such as a keyboard or mouse permit an administrator to provide data and control inputs to the microprocessor. Output generated by the microprocessor can be displayed to the administrator by an output device 64 such as a monitor. Program instructions initially stored in ROM 54 and storage device 58 are typically transferred into RAM 56 to facilitate run-time operation of the application implemented by microprocessor 52.

Each of the different types of nodes in FIG. 1 has a different responsibility. The primary application implemented by the communication nodes, e.g. 20, 22, 26, etc., involves handling bi-directional communication channels in support of communications between the communication devices of the users. The primary application associated with the administration module 24 involves the setup, control and routing of communication channels between an originating user and a destination user. The primary application implemented by the resource broker module 36 relates to obtaining and storing availability and cost information received from respective service providers for providing communication services, accessing such information upon the request of a service provider, and transmitting a reply of such information upon the request of a service provider. It will be apparent to those skilled in the art that the stored program instructions in the nodes will support the respective application programs which include the implementation of the illustrative steps of an embodiment of the method in accordance with the present invention as described below.

FIG. 3 shows steps in accordance with an illustrative method of the present invention. In this example, a user associated with VOIP device 14 makes a call origination request in which the VOIP device 32 is the destination. In this example, service provider 12 functions as the primary service provider. However, communication node 22 that is part of the service provider 12 is unavailable to handle the subject call. This could be due to communication node 22 being out of service because of a problem or because communication node 22 is already at maximum capacity handling other calls. In this scenario, the service provider 12 must either select an alternate communication node that is part of a different service provider to carry a portion of the requested call or abort the call request.

In step 100 the service provider 12 receives the subject of VOIP call request initiated by the user of device 14. In step 102 a determination is made, such as by the administration module 24, of whether alternate path routing is needed. A NO determination by step 102 results in the call being routed over a path selected by the primary service provider. Such a NO determination would have been made if communication node 22 was available to handle the call request. However, a YES determination by step 102 is made by administration module 24 in this example since communication node 22 is not available to handle the call.

In step 106 administration module 24 queries the resource broker module 36 for availability and cost for specified call path services from other service providers. In this example the call path services specified is for availability and cost for a communication node of another service provider to carry the call between communication node 20 and terminating communication node 30. In this example, the resource broker module 36 determines that both communication node 26 and 28 associated with respective service providers are available.

In step 108 the administration module 24 receives a reply to its query from the resource broker module 36. The reply contains availability and cost information with regard to carrying the call by communication nodes 26 and 28. The cost information contained by resource broker module 36 relating to these nodes is established and controlled by the respective service providers. Now administration module 24 has a choice of two nodes (26 and 28) that are available to carry the portion of the call between nodes 20 and 30. In step 110 the administration module 24 makes a rules based selection of resources to be used for the subject call path, i.e. one of nodes 26 and 28 is selected. In accordance with one criteria, the selection might be based only on the lowest cost. However, those skilled in the art will understand that substantial flexibility exists with regard to rules that can be used to make such a choice. For example, quality of service, associated time delay, node capacity, etc. could be used as independent factors that control the selection decision, or could be used in combination with a variety of factors that can be weighted in a defined rule based equation. In general, the conditions defined by the respective service providers under which services could be provided by the respective nodes are provided in reply to the query. In this example administration module 24 selects communication node 26 associated with the respective service provider based on cost. In step 112 the primary service provider 12 having established that communication node 26 will handle a part of the call path completes the call path set up consisting of nodes 18, 20, 26, and 30. This completes the call path selection process as indicated at END step 114.

Although exemplary implementaions of the invention have been depicted and described in detail herein, it will be apparent to those skilled in the art that various modifications, additions, subsitutions, and the like can be made without departing from the spirit of the invention. With regard to the illustrative steps of an embodiment of a method of the present invention, other steps can be substituted, steps deleted, and/or the steps could be practiced in a different order or by a different apparatus. Although the administration module of the primary service provider collected the call path information and made the call path selection based on this information, it will be apparent that other nodes in the network could be authorized to provide the same functionality. For example, communication node 22 as well as other peripheral communication nodes of the primary service provider could be utilized. Alternatively, the rules desired to be utilized for making such decisions by the primary service provider 12 could be contained in and implemented by the resource broker module 36 itself.

The scope of the invention is defined in the following claims.

I claim:

1. A method implemented in a voice over internet protocol (VOIP) system for selecting communication nodes to carry a requested call from a user comprising the steps of:
determining by the primary VOIP service provider of the user that at least one communication node of another service provider is needed to carry a portion of the requested call;
determining conditions on a per call basis under which one or more other service providers with respective nodes suited for carrying the portion of the requested call would carry the portion of the call, the conditions including cost for the carrying of the portion of the call;
selecting one node of the one or more service providers to carry the portion of the call based on predetermined rules that operated on the conditions;
completing a path to carry the call that includes the selected one node.

2. The method of claim 1 wherein the step of determining conditions comprises the step of querying a resource broker module that contains said conditions by administration module of the primary VOIP service provider.

3. The method of claim 1 wherein the step of selecting is implemented by an administration module of the primary VOIP service provider.

4. The method of claim 2 wherein the step of selecting is implemented by administration module of the primary VOIP service provider.

5. The method of claim 1 wherein the step of selecting comprises selecting the one node with the lowest cost for carrying the portion of the call as implemented by the predetermined rules.

6. The method of claim 1 wherein the step of selecting the one node comprises implementing the predetermined rules which weight a plurality of factors to determine the one node to be selected.

7. A node of a primary service provider of a voice over internet protocol (VOIP) system that selects communication nodes to carry a requested call from a user comprising:
a microprocessor controlled apparatus that determines that at least one communication node of another service provider is needed to carry a portion of the requested call;
the microprocessor controlled apparatus determines conditions on a per call basis under which one or more other service providers with respective nodes suited for carrying the portion of the requested call would carry the portion of the call, the conditions including cost for the carrying of the portion of the call;
the microprocessor controlled apparatus selects one node of the one or more service providers to carry the portion of the call based on predetermined rules that operated on the conditions;
the microprocessor controlled apparatus causing completion of a path to carry the call that includes the selected one node.

8. The device of claim 7 further comprising the microprocessor controlled apparatus querying a resource broker module that contains said conditions.

9. The device of claim 7 wherein the microprocessor controlled apparatus selects the one node with the lowest cost for carrying the portion of the call as implemented by the predetermined rules.

10. The device of claim 7 wherein the microprocessor controlled apparatus selects the one node by implementing the predetermined rules which weight a plurality of factors to determine the one node to be selected.

11. A resource broker module that supports a primary service provider of a voice over internet protocol (VOIP) system to select a communication node to carry a requested call from a user comprising:
a microprocessor controlled apparatus that stores conditions under which one or more other service providers with respective nodes suited for carrying a portion of the requested call would carry the portion of the call, the conditions including cost for the carrying of the portion of the call;
the microprocessor controlled apparatus receiving a query from a first node of the primary service provider where the query seeks the conditions on a per call basis associated with each of the respective nodes of the other service providers carrying the portion of the requested call;
the microprocessor controlled apparatus transmitting, in response to the query from the first node of the primary service provider, a reply containing the conditions associated with each of the respective nodes of the other service providers carrying the portion of the requested call, thereby enabling the first node to select one of the respective nodes of the one or more other service providers to carry the portion of the call.

12. The resource broker module of claim 11 wherein the conditions include a plurality of factors to be weighted in the selection of the one node.
